(19) United States
(12) Patent Application Publication
(10) Pub. No.: US 2016/0370780 A1
(43) Pub. Date: Dec. 22, 2016

(54) PROGRAMMABLE CONTROLLER

(71) Applicant: KABUSHIKI KAISHA YASKAWA DENKI, Kitakyushu-shi (JP)

(72) Inventors: Koji HARA, Kitakyushu-shi (JP); Masaomi KUDO, Kitakyushu-shi (JP)

(73) Assignee: KABUSHIKI KAISHA YASKAWA DENKI, Kitakyushu-shi (JP)

(21) Appl. No.: 15/182,619

(22) Filed: Jun. 15, 2016

(30) Foreign Application Priority Data
Jun. 18, 2015 (JP) 2015-122868

(51) Int. Cl. G05B 19/042

(52) U.S. Cl. CPC G05B 19/0423; G05B 2219/25208; G05B 2219/25096

(57) ABSTRACT

A programmable controller to control a control machine includes an arithmetic processor, a storage, and a selector. The storage stores a plurality of definition files and a control program. The definition files each define a corresponding relationship between specification information and a plurality of control elements of the control machine. The specification information specifies an input-output end from and to which the programmable controller receives and outputs at least one of a command and information. The control program is executable by the arithmetic processor to input and output at least one of the command and the information from and to the control elements based on at least one of the definition files. The selector is configured to select the at least one definition file to use as a basis on which the arithmetic processor executes the control program.

### CROSS-REFERENCE TO RELATED APPLICATIONS

The present application claims priority under 35 U.S.C. §119 to Japanese Patent Application No. 2015-122868, filed Jun. 18, 2015. The contents of this application are incorporated herein by reference in their entirety.

### BACKGROUND

### Field of the Invention

The embodiments disclosed herein relate to a programmable controller.

### Discussion of the Background

Japanese Unexamined Patent Application Publication No. 2003-167608 discloses a programmable controller to manage, as formation information, kinds and arrangements of input devices and output devices connected to the programmable controller.

### SUMMARY

According to one aspect of the present disclosure, a programmable controller to control a control machine includes an arithmetic processor, a storage, and a selector. The storage stores a plurality of definition files and a control program. The plurality of definition files each define a corresponding relationship between specification information and a plurality of control elements of the control machine. The specification information specifies an input-output end from and to which the programmable controller receives and outputs at least one of a command and information. The control program is executable by the arithmetic processor to input and output at least one of the command and the information from and to the plurality of control elements based on at least one definition file among the plurality of definition files. The selector is configured to select the at least one definition file to use as a basis on which the arithmetic processor executes the control program.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a block diagram schematically illustrating a configuration of a machine control system including a programmable controller according to an embodiment, and exemplifies a connection configuration when a production machine includes standard shafts only;

FIG. 2 exemplifies a connection configuration when the production machine includes the standard shafts and one option shaft;

FIG. 3 exemplifies a connection configuration when the production machine includes the standard shafts and two option shafts;

FIG. 4 is a block diagram illustrating a storage configuration of various information in a memory;

FIG. 5 is a table illustrating exemplary specific contents of a standard definition file corresponding to the connection configuration of FIG. 1;

FIG. 6 is a table illustrating exemplary specific contents of a standard+first option definition file corresponding to the connection configuration of FIG. 2;

FIG. 7 is a table illustrating exemplary specific contents of a standard+second option definition file corresponding to the connection configuration of FIG. 3;

FIG. 8 exemplifies a connection configuration to which an I/O control unit is added and in which the production machine includes the standard shafts and one option shaft that are irregularly connected;

FIG. 9 is a table illustrating exemplary specific contents of a standard+first option definition file corresponding to the connection configuration of FIG. 8;

FIG. 10 illustrates a specific description of an exclusive control program as a comparative example, which corresponds to the standard definition file of FIG. 5;

FIG. 11 illustrates a specific description of an exclusive control program as a comparative example, which corresponds to the standard +first option definition file of FIG. 6;

FIG. 12 illustrates a specific description of an exclusive control program as a comparative example, which corresponds to the standard+second option definition file of FIG. 7;

FIG. 13 illustrates a specific description of a common control program according to the embodiment;

FIG. 14 is a flowchart of a control procedure of a system program executed in a ROM by a CPU of the programmable controller;

FIG. 15 is a block diagram illustrating a modification by network connection, and exemplifies an irregular connection configuration when the production machine includes the standard shafts and one option shaft; and

FIG. 16 is a table illustrating exemplary specific contents of a standard +first option definition file corresponding to the connection configuration of FIG. 15.

### DESCRIPTION OF THE EMBODIMENTS

The embodiments will now be described with reference to the accompanying drawings, wherein like reference numerals designate corresponding or identical elements throughout the various drawings.

### Schematic Configuration of Machine Control System

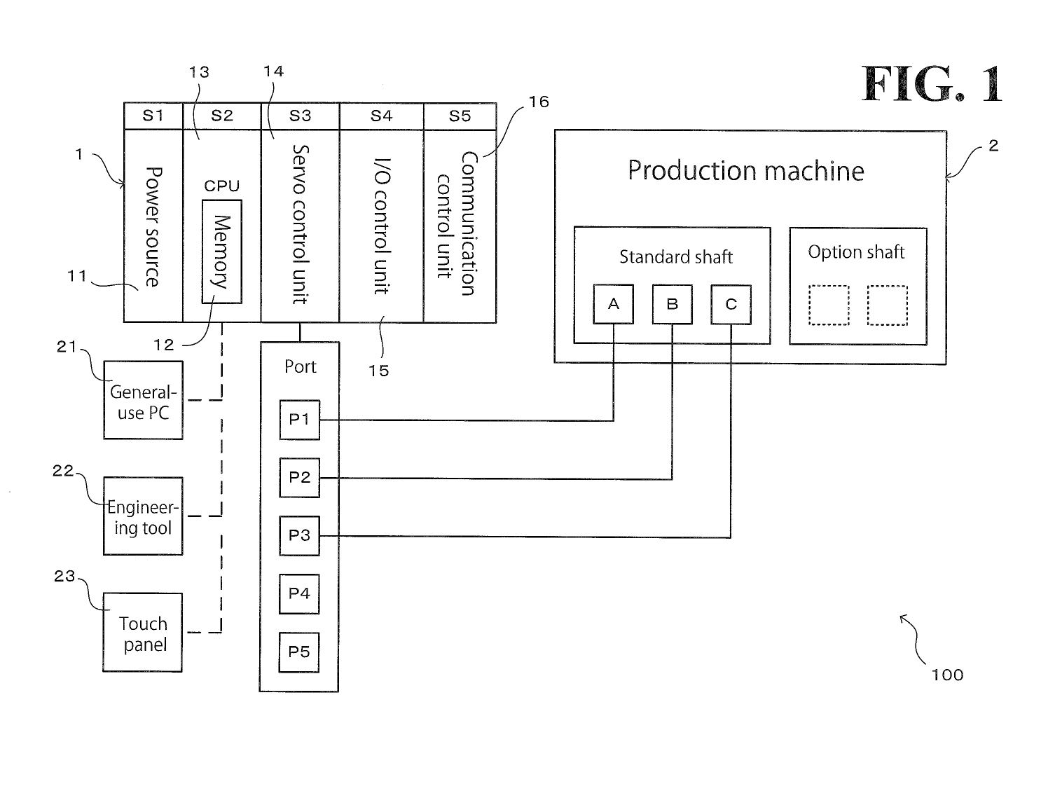

FIGS. 1, 2, and 3 are block diagrams illustrating a machine control system including a programmable controller according to the embodiment. In FIG. 1, the machine control system 100 includes the programmable controller 1 and a production machine 2, which is an exemplary control machine.

The programmable controller 1 is what is called an upper-level controller to control operation and information of control elements of the production machine 2 based on a control program and definition files stored in a memory, described later. In the illustrated example, the programmable controller 1 is provided with a power source 11, a CPU 13, a servo control unit 14, an I/O control unit 15, and a communication control unit 16, which correspond to slots S1 to S5 of the main body of the programmable controller 1 in ascending order. The CPU 13 includes the memory 12.

The power source 11 functions to supply power to each component of the programmable controller 1.

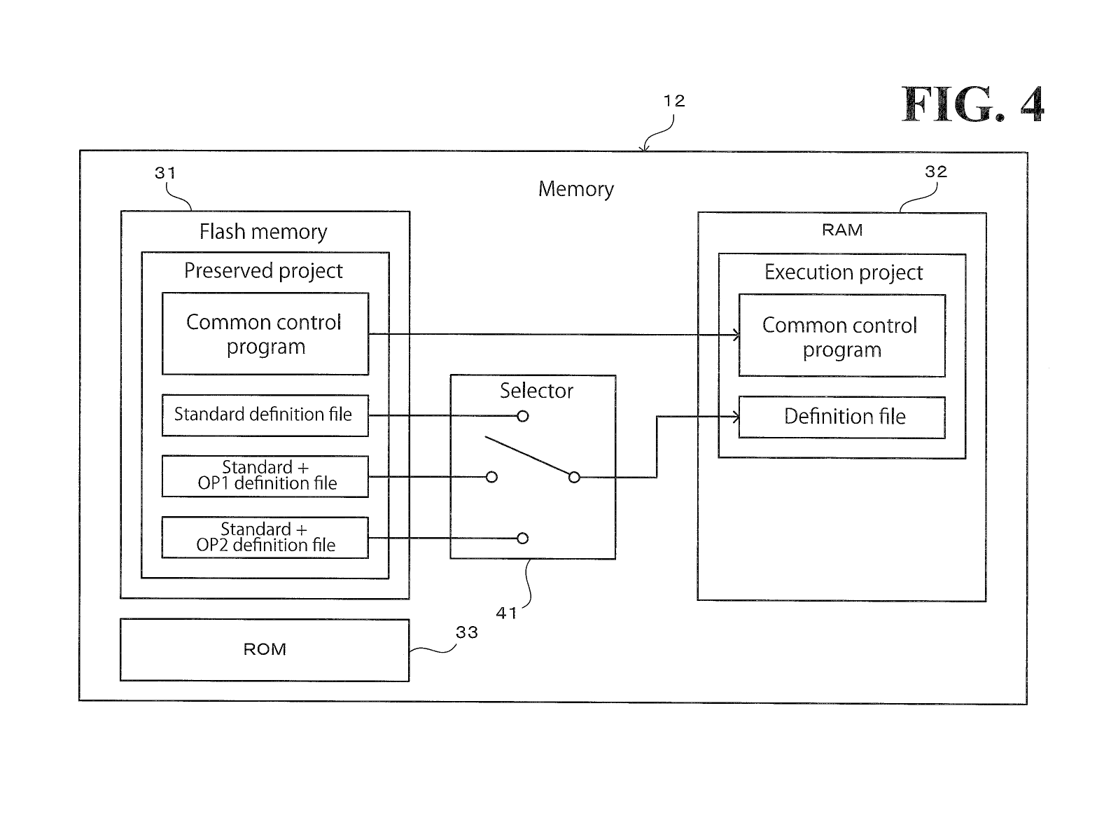

The CPU 13 (which is the arithmetic processor) functions to transmit and receive commands and information to and from each component of the programmable controller 1 based on a control program and a definition file (see FIG. 4, described later) stored in the incorporated memory 12 (which is the storage) so as to control the whole programmable controller 1. A configuration of the memory 12 and the contents of stored information will be described in detail later.

The production machine 2, described later, includes drive shafts (actuators) as the control elements. The servo control unit 14 is connected to each of the drive shafts and functions to output commands from the CPU 13 to the drive shafts.

The production machine 2, described later, includes auxiliary devices such as various sensors, lamps, and solenoids as the control elements. The I/O control unit 15 is connected to the auxiliary devices and functions to make commands and information input and output between the I/O control unit 15 and the CPU 13.

The communication control unit 16 is connected to programmable controllers of other machine control systems through suitable communication lines and functions to control transmission and reception of information to and from the CPU 13 so as to perform cooperation with the programmable controllers.

The servo control unit 14, the I/O control unit 15, and the communication control unit 16 each include a plurality of ports (which are the connectors), and are connected to a plurality of control elements of the production machine 2 and other programmable controllers through the ports. The plurality of ports are discriminated in advance as input and output ports of commands and information so as to specify the ports on the hardware level. In order to avoid complication of the drawings and facilitate description, assume that the servo control unit 14 includes five ports P1, P2, P3, P4, and P5 in the example illustrated in FIGS. 1 to 3. Only the connection relationships between the ports P1 to P5 of the servo control unit 14 and drive shafts A, B, C, D, and E of the production machine 2 are illustrated in FIGS. 1 to 3 and will be described below. In the example of this embodiment, outlets of male plugs of cables are supposed as specific configurations of the ports P1 to P5. Other coupling configurations such as female connectors and sockets, however, may be employed. It is noted that reference numerals P1 to P5 of the ports correspond to the specification information disclosed in the claims.

One of a general-use personal computer 21 (abbreviated to general-use PC in FIGS. 1 to 3; the same applies below), an engineering tool 22, and a touch panel 23 is connectable to the CPU 13. The general-use PC 21 is a tool for the developer and used for developing, for example, a control project, described later (see FIG. 4, described later), including the control program. The engineering tool 22 is a tool for the operator and used for adjusting the control project. The touch panel 23 is a tool for the operator and used for operating the machine control system 100 based on the control project. The general-use PC 21, the engineering tool 22, and the touch panel 23 each include a suitable operation unit and display, which make it possible to, for example, display and set the stored contents of the memory 12 and various parameters and input various commands.

The production machine 2 is an assembly of mechanical elements to perform predetermined actions by driving movable portions by rotary or linear motors (actuators) incorporated in the production machine 2. Additionally, the production machine 2 performs cooperative control using auxiliary devices such as various sensors, lamps, and solenoids. Each of these motors and a servo amplifier (not illustrated) to control the motor will be referred to as drive shaft. It is noted that it is not necessary to correspond the motors to the servo amplifiers in one-to-one manner. In a non-limiting embodiment, a single multi-axis control servo amplifier may control a plurality of motors. In this case as well, the motors will be each referred to as drive shaft and are regarded as units to be respectively connected to the ports P1 to P5 individually.

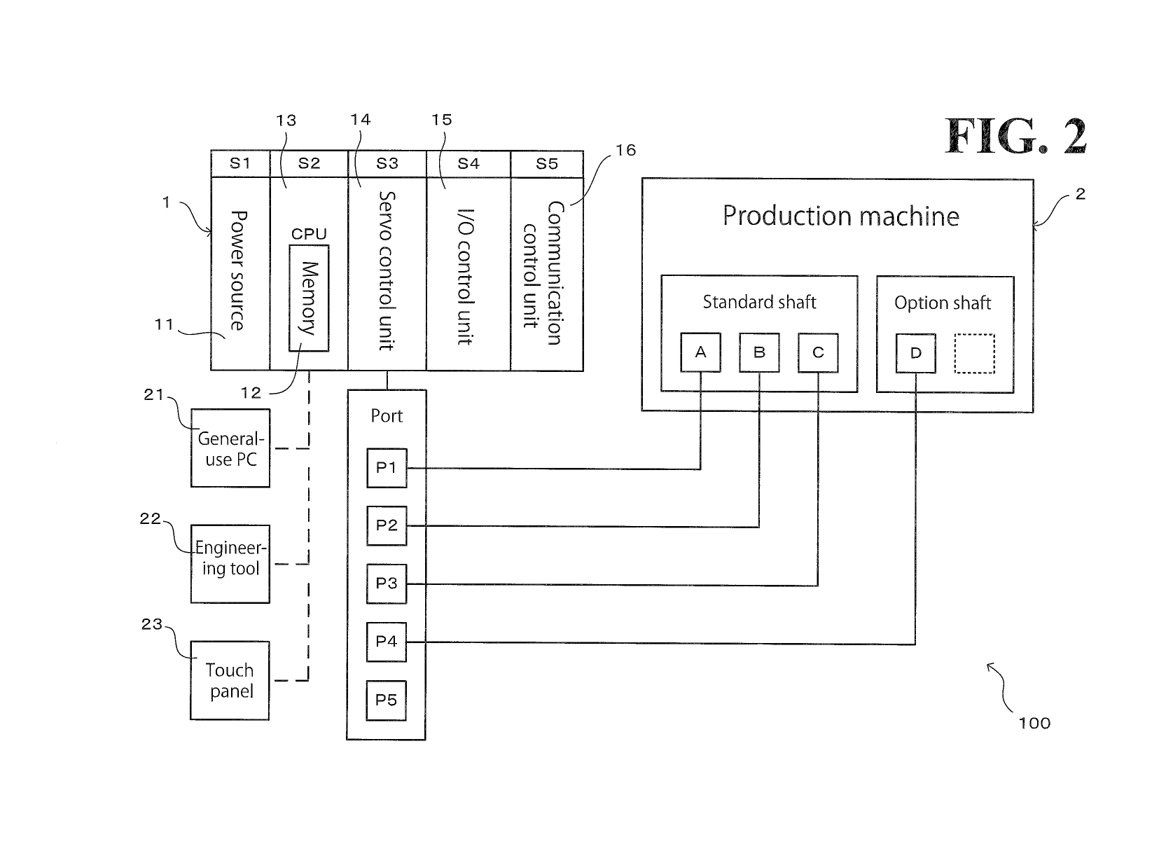

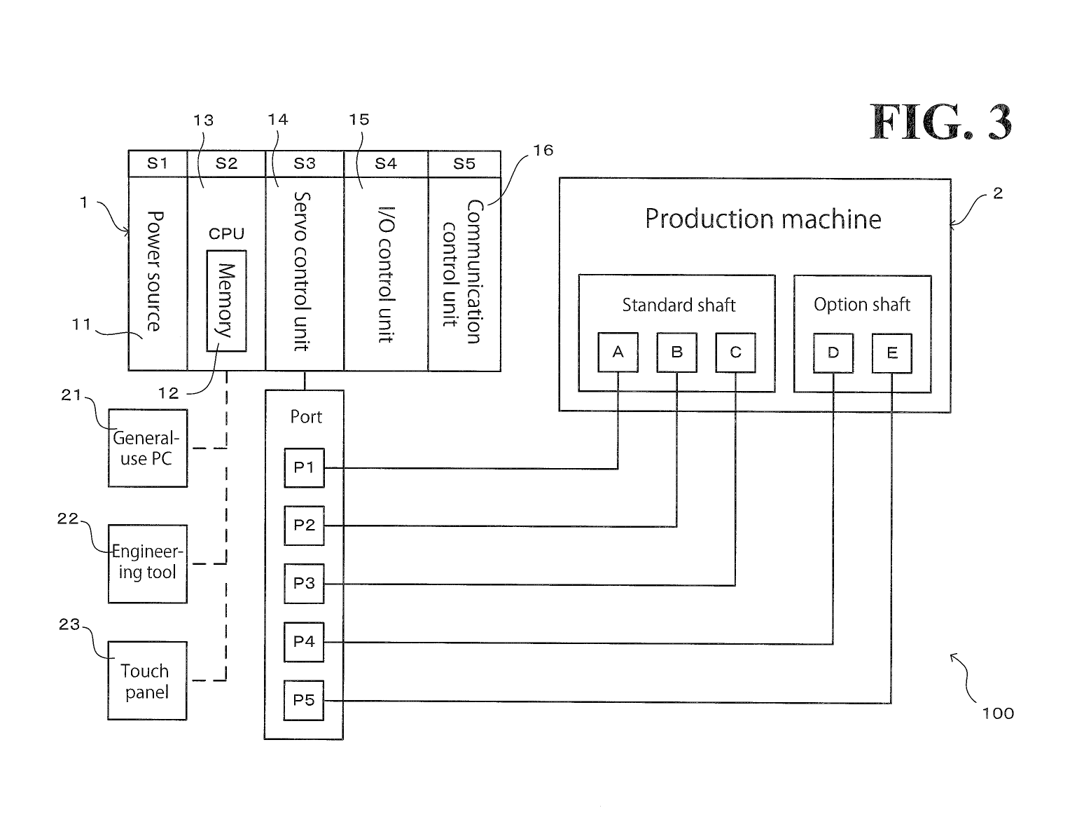

The production machine 2 in the example illustrated in FIG. 1 only includes three standard shafts A, B, and C. The standard shafts A, B, and C are drive shafts that are required minimum for making the production machine 2 perform standard actions. The production machine 2 in the example illustrated in FIG. 2 includes one option shaft D in addition to the standard configuration made up of the three standard shafts A, B, and C. The option shaft D is a drive shaft to make the production machine 2 perform an action added to the standard actions by the operator as desired. The production machine 2 in the example illustrated in FIG. 3 includes two option shafts D and E in addition to the three standard shafts A, B, and C. In each of the examples illustrated in FIGS. 1 to 3, the drive shafts A to E are connected in sequence to the ports P1 to P5 in ascending order. In general, the normal production machine 2 includes, as control elements, a plurality of auxiliary devices connected to the I/O control unit 15 in addition to the drive shafts connected to the servo control unit 14 of the programmable controller 1. As described above, however, FIGS. 1 to 3 only illustrate the connection relationships between the ports P1 to P5 of the servo control unit 14 and the drive shafts A, B, C, D, and E of the production machine 2.

As described above, the programmable controller 1 is connected to a plurality of control elements (drive shafts and auxiliary devices) of the production machine 2 through the ports. The CPU 13 performs the input and output of commands and/or information with respect to the control elements in accordance with the control program. Thus, the programmable controller 1 controls actions of the production machine 2. Other than the control program, however, it is necessary for the programmable controller 1 to individually prepare definition files for respective occasions in advance. A definition file defines, as software, which control elements are actually connected in which configuration.

Properties of this Embodiment

As described above, the production machine 2 may have the connection configuration changed in various manners by randomly adding and connecting option shafts separate from the standard shafts. It is necessary to individually prepare and manage definition files as well in accordance with respective connection configurations of the production machine 2.

In contrast, in this embodiment, the memory 12 of the programmable controller 1 stores a plurality of definition files and a control program. A definition file defines which control element is connected to which of the ports in accordance with each connection configuration of the production machine 2. The control program causes the CPU 13 to perform the input and output of commands and/or information with respect to the plurality of control elements based on at least one of the plurality of definition files. The programmable controller 1 also includes a selector (described in detail later) to select based on which of the plurality of definition files the CPU 13 is made to execute the control program. Thus, software of the production machine 2 of large variation can be used in common to facilitate development and operation management of the software.

### Storage Configuration of Memory

FIG. 4 illustrates a storage configuration of various kinds of infonnation in the memory 12. In FIG. 4, the memory 12 includes a flash memory 31, a RAM 32, and a ROM 33.

The flash memory 31 (which is the non-volatile storage) is what is called a non-volatile storage in which the stored contents are readable and rewritable when the power is supplied and from which the stored contents are not erased even when the power supply is interrupted. In this embodiment, the flash memory 31 stores one preserved project (control project) made up of one common control program and a plurality of definition files. An exemplary preserved project illustrated in FIG. 4 stores three definition files as the plurality of definition files, namely, a standard definition file, a standard+first option definition file (abbreviated to standard+OP1 definition file in FIG. 4), and a standard+second option definition file (abbreviated to standard+OP2 definition file in FIG. 4). The common control program describes a control procedure for causing the CPU 13 to perform the input and output of commands and/or information with respect to the control elements of the production machine 2 based on one of the three definition files. Detailed description will be made later on specific contents of the common control program and the definition files. The flash memory 31 may be replaced with a hard disk drive, which is also a non-volatile storage.

The RAM 32 (which is the volatile storage) is what is called a volatile storage in which the stored contents are readable and rewritable when the power is supplied and from which the stored contents are erased when the power supply is interrupted. The RAM 32 stores one execution project (control project) made up of the common control program and one definition file transferred from the flash memory 31. The access speed of the RAM 32 is relatively high. The CPU 13 accesses and executes the execution project stored in the RAM 32 so as to increase the processing speed.

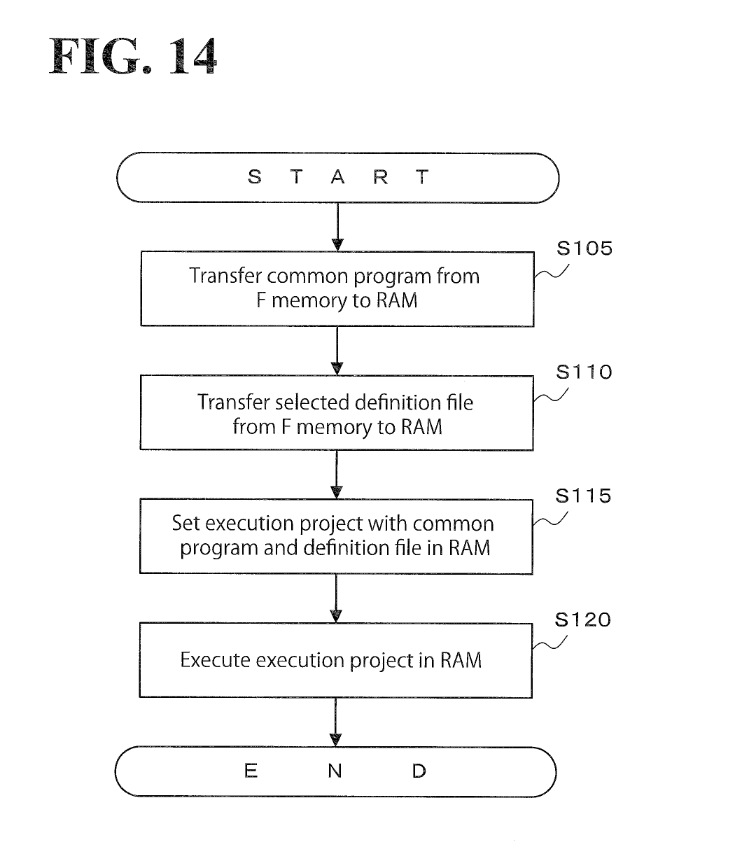

The ROM 33 is what is called a non-volatile storage in which the stored contents are only readable when the power is supplied and from which the stored contents are not erased even when the power supply is interrupted. In this embodiment, the ROM 33 stores a system program for, for example, transferring the stored contents from the flash memory 31 to the RAM 32 when the programmable controller 1 is powered (see FIG. 14, described later).

When the stored contents are transferred from the flash memory 31 to the RAM 32, the selector 41 selects one of the plurality of definition files in the preserved project stored in the flash memory 31 and transfers the selected definition file to the RAM 32. In the example of this embodiment, the selector 41 includes a hardware switch such as a rotary switch, and the selector 41 is operated to select the definition file. It is noted that the selector 41 may be arranged to set the contents of a system register (not illustrated) of the CPU 13 so as to select the definition file by means of software.

### Exemplary Specific Contents of Definition Files

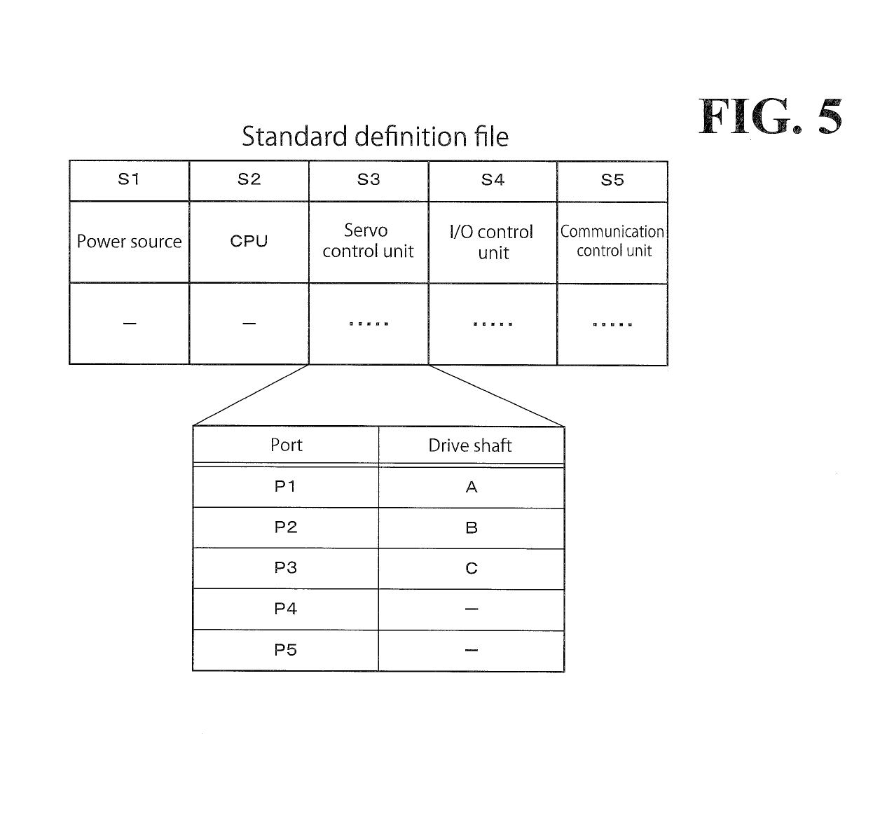

FIGS. 5 to 7 illustrate exemplary specific contents of the three definition files of the preserved project in FIG. 4. The contents of each definition file are illustrated in a table indicating a connection configuration for each of the control units attached to the slots. It is noted that FIGS. 5 to 7 illustrate examples in which a connection configuration of the servo control unit 14 is extracted, that is, only a combination of connections between the ports P1 to P5 and the drive shafts A to E is extracted.

FIG. 5 corresponds to the standard definition file and illustrates an example of the connection configuration illustrated in FIG. 1 for driving only the standard drive shafts A, B, and C of the production machine 2 and making the production machine 2 perform standard actions.

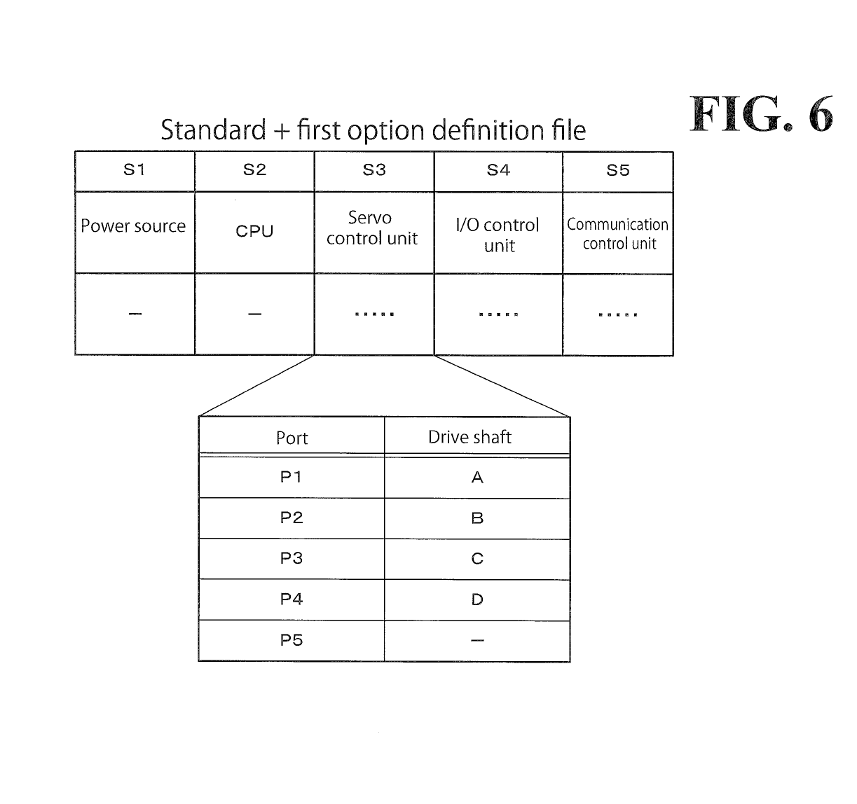

FIG. 6 corresponds to the standard +first option definition file and illustrates an example of the connection configuration illustrated in FIG. 2 for making the production machine 2 perform an action of the option shaft D in addition to the standard actions. The example illustrated in FIG. 6 is the connection configuration of the standard definition file to which connection of the option shaft D is added.

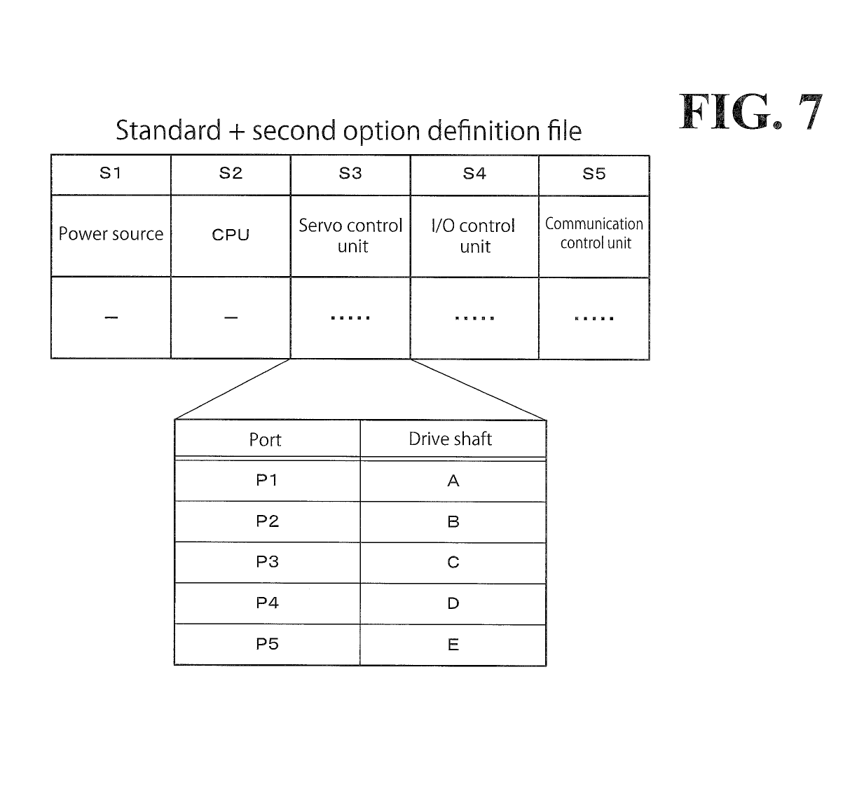

FIG. 7 corresponds to the standard+second option definition file and illustrates an example of the connection configuration illustrated in FIG. 3 for making the production machine 2 perform actions of the option shafts D and E in addition to the standard actions.

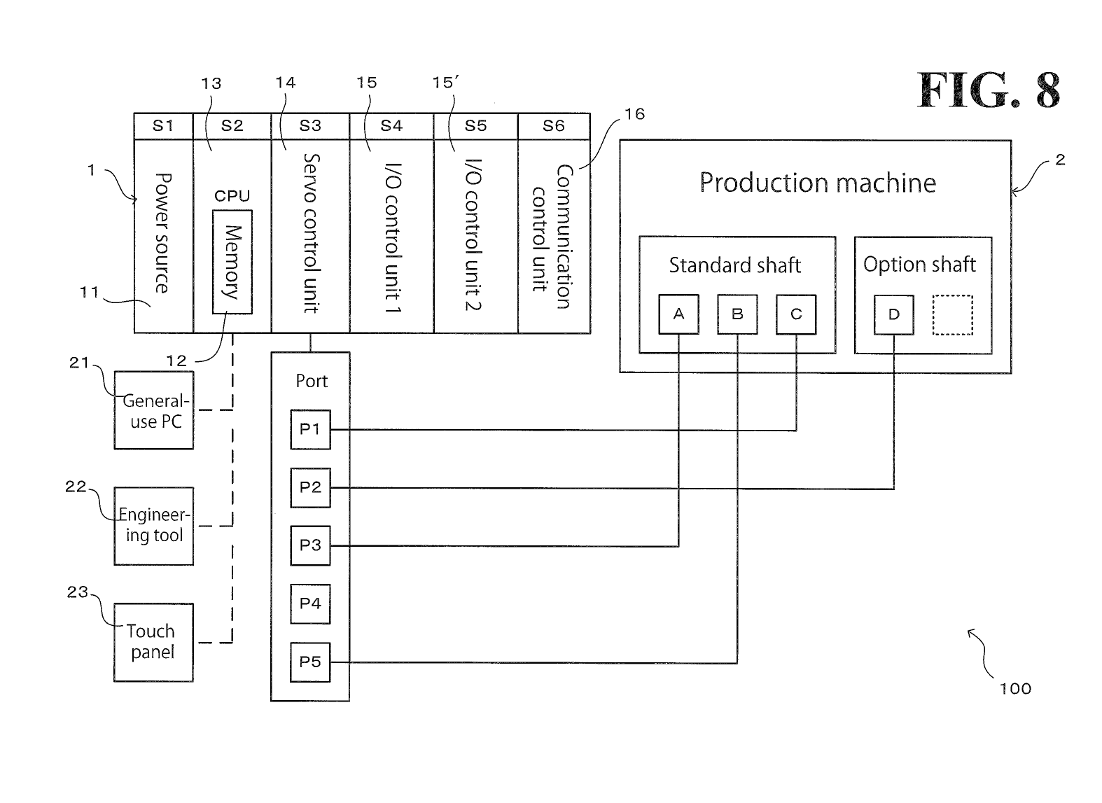

It is noted that since the ports P1 to P5 are compatible with each other on the hardware level, the contents of the definition files may have various combinations other than the illustrated examples. For example, even when the production machine 2 includes the four drive shafts A to D, as illustrated in FIG. 2, the drive shafts A to D may be irregularly connected to the ports P1 to P5, as illustrated in FIG. 8 (the alphabetical order of the drive shafts does not correspond to the ascending order of the ports). In this case, a definition file may be prepared which corresponds to an actual connection configuration (connection combination) of the ports P1 to P5 to the drive shafts A to E, as illustrated in FIG. 9. The number of the control units attached to each slot is not necessarily one. When the production machine 2 includes a large number of auxiliary devices, for example, a plurality of I/O control units 15 and 15′ may be attached to different slots S4 and S5, as illustrated in FIG. 8. Even in this case, a definition file may be prepared which suitably corresponds to the additional control units, as illustrated in FIG. 9. When the actual components are different from the contents of the definition file, abnormality is detected to prevent the production machine 2 from operating so as to improve safety.

### Common Control Program

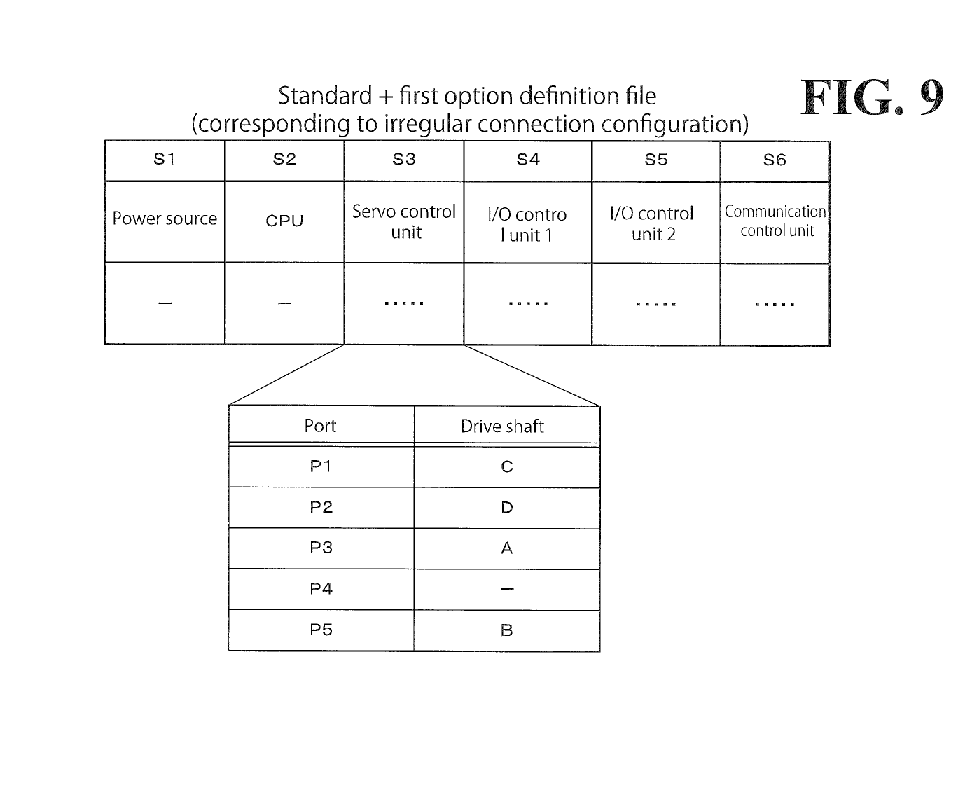

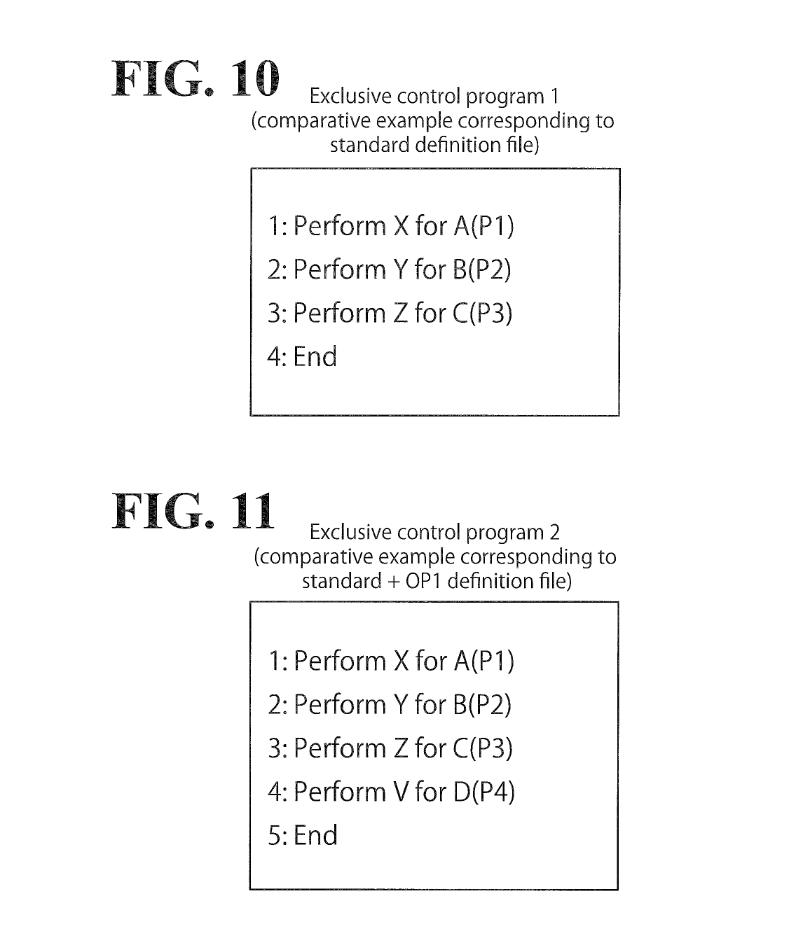

As a comparative example, an exclusive control program that is executed in accordance with only the above-described standard definition file is arranged in such a manner that it suffices that drive processing X, Y, and Z is unconditionally performed for the respective drive shafts A, B, and C, as illustrated in FIG. 10. That is, it suffices that based on the standard definition file, commands are unconditionally output to the ports P1, P2, and P3 corresponding to the respective drive shafts A, B, and C.

As a comparative example, an exclusive control program that is executed in accordance with only the above-described standard+first option definition file (see FIG. 6) is arranged in such a manner that it suffices that drive processing X, Y, Z, and V is unconditionally performed for the respective drive shafts A, B, C, and D, as illustrated in FIG. 11. That is, it suffices that based on the standard+first option definition file, commands are unconditionally output to the ports P1, P2, P3, and P4 corresponding to the respective drive shafts A, B, C, and D.

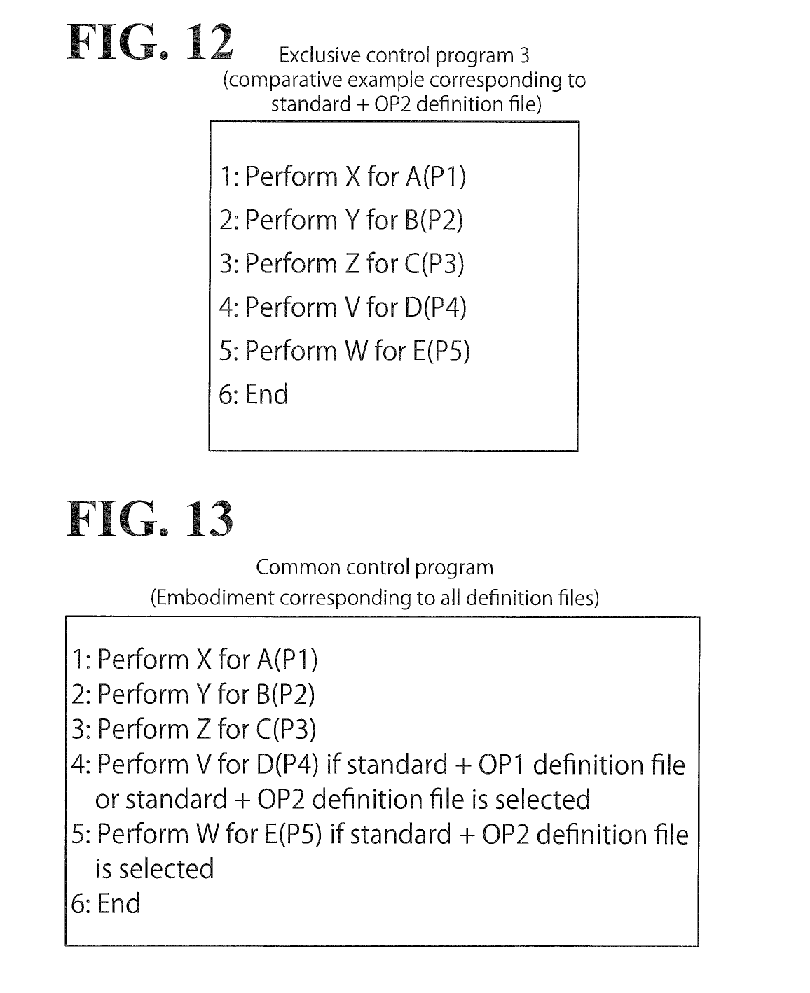

As a comparative example, an exclusive control program that is executed in accordance with only the above-described standard+second option definition file is arranged in such a manner that it suffices that drive processing X, Y, Z, V, and W is unconditionally performed for the respective drive shafts A, B, C, D, and E, as illustrated in FIG. 12. That is, it suffices that based on the standard+second option definition file, commands are unconditionally output to the ports P1, P2, P3, P4, and P5 corresponding to the respective drive shafts A, B, C, D, and E.

The common control program used in this embodiment, however, is described in such a manner that even when the common control program is combined with any of the plurality of definition files prepared in advance in the preserved project, the common control program can be appropriately executed. Specifically, as illustrated in FIG. 13, the drive processing X, Y, and Z is unconditionally performed for the respective drive shafts A, B, and C. Concerning the option shaft D, however, only when it is confirmed that one of the standard+first option definition file and the standard+second option definition file, which define connection of the option shaft D, is selected, the drive processing V is performed (a command is output to the corresponding port P4). Concerning the option shaft E, only when it is confirmed that the standard+second option definition file, which defines connection of the option shaft E, is selected, the drive processing W is performed (a command is output to the corresponding port P5). Thus, the drive processing is performed for each of the option shafts under the connection conditions so as to apply the single common control program to the standard definition files and the option definition files in common.

### Management Method of Memory

With the storage configuration of the memory 12 illustrated in FIG. 4, selection transfer and execution of the common control program and each of the definition files described above are managed. In the storage configuration of the memory 12, the common control program and each of the definition files, which have been prepared in the general-use PC 21 or the engineering tool 22, are temporarily stored in the RAM 32. Then, all the stored contents are transferred to the flash memory 31 and stored as a preserved project. After that, setting is performed by the selector 41 to select which of the definition files in the preserved project is used to constitute an execution project, and in this state, the programmable controller 1 is started up. Thus, the CPU 13 first transfers the common program and the selected one definition file from the flash memory 31 to the RAM 32 in accordance with the system program in the ROM 33, and the common program and the definition file are combined to set an execution project. Then, the CPU 13 executes the execution project stored in the RAM 32 so as to control the production machine 2.

Even when the production machine 2 has a different connection configuration, the selector 41 merely selects a definition file corresponding to the connection configuration so as to set an appropriate execution project in the RAM 32 and make the CPU 13 execute the execution project. In other words, definition files corresponding to various connection configurations are merely prepared in advance in the preserved project in the flash memory 31 so as to use the project in common. This facilitates the management and improves development efficiency of the control program.

### Control Flow of System Program

A control procedure of the system program executed in the ROM 33 by the CPU 13 in order to implement the above-described functions will be described step by step by referring to FIG. 14. In FIG. 14, the processing described in this flow is started when the programmable controller 1 is restarted (or powered and started up) after the operator operates the selector 41 in advance to set which definition file is applied. It is noted that when the programmable controller 1 is restarted, the RAM 32 is in an initial state in which all the stored contents are erased.

First, at step S105, the CPU 13 transfers only the common control program from the flash memory 31 (abbreviated to F memory in FIG. 14) to the RAM 32.

Next, the processing proceeds to step 5110, and the CPU 13 transfers a definition file selected by the selector 41 from the flash memory 31 to the RAM 32.

Next, the processing proceeds to step S115, and the CPU 13 sets an execution project with the common control program and the definition file in the RAM 32, which have been transferred at step S105 and step S110.

Next, the processing proceeds to step S120, and the CPU 13 executes the execution project in the RAM 32, which has been set at step S115. Thus, the CPU 13 controls actions and information of the control elements of the production machine 2 through the ports. Then, this flow is ended.

Effects of this Embodiment

As has been described heretofore, with the programmable controller 1 of this embodiment, the memory 12 stores the plurality of definition files and the common control program. The definition files each define a corresponding relationship between the numerals P1 to P5 of the ports and the plurality of control elements of the production machine 2. The numerals P1 to P5 of the ports specify an input-output end from and to which the programmable controller receives and outputs at least one of a command and information. The common control program causes the CPU 13 to perform the input and output of commands and/or information with respect to the plurality of control elements based on at least one of the plurality of definition files. The programmable controller 1 also includes the selector 41 to select based on which of the plurality of definition files the CPU 13 is made to execute the common control program. Thus, even when the production machine 2 has various connection configurations, the selector 41 is merely operated to appropriately control the production machine 2 of each connection configuration based on the corresponding definition file. This facilitates appropriate control in accordance with various changes in the connection configuration of the production machine 2.

In this embodiment, in particular, the programmable controller 1 includes the plurality of control elements and the plurality of ports P1 to P5 respectively connected to the control elements. With the numerals P1 to P5 of these ports, the input-output ends of commands and/or information are specified. Thus, the port numerals P1 to P5, which are set in advance on the hardware level, are used to readily specify the input-output ends of commands and/or information.

In this embodiment, in particular, the control program is described as the common control program to cause the CPU 13 to perform the input and output of commands and/or information with respect to only the control elements which have the connection defined by the definition file selected by the selector 41. Thus, the common control program can be integrated as a single control program to function for the plurality of definition files in common.

In this embodiment, in particular, the selector 41 substantially selects a definition file only when the programmable controller 1 to execute the system program in FIG. 14 is started up. The connection configuration of the production machine 2 is changed while the power supply is interrupted. It is not preferable from a safety point of view to change the definition file when the power is supplied and the connection configuration is not changed. Consequently, only at the start time of the programmable controller 1 (that is, when the programmable controller 1 is powered), the selector 41 selects the definition file to improve safety.

In this embodiment, in particular, the memory 12 includes the volatile RAM 32 and the non-volatile flash memory 31. The flash memory 31 stores the plurality of definition files and the common control program. At the start time of the programmable controller 1, the RAM 32 reads the definition file selected by the selector 41 and the common control program from the flash memory 31 and stores the definition file and the common control program. Then, based on the definition file stored in the RAM 32, the CPU 13 executes the common control program stored in the same RAM 32. Thus, even when the power supply is interrupted, the plurality of definition files and the common control program stored in the flash memory 31 can be all kept without being erased. Also, at the start time of the programmable controller 1, only the required definition file and the common control program can be read by the RAM 32 having a relatively high access speed and executed. This improves the processing speed of the control and the memory efficiency. In this embodiment, the flash memory 31 and the RAM 32 are used for different purposes. This, however, should not be construed in a limiting sense. For example, the memory 12 does not include the RAM 32 but may include the flash memory 31 and the ROM 33 only. Thus, with the definition file selected by the selector 41 and the common control program, the execution project is set in the flash memory 31 and executed.

### Modification

The present invention is not limited to the above-described embodiment. Various modifications are possible without departing from the subject matter. One of such modifications will now be described.

### 1. When the Control Elements are Connected Through Network

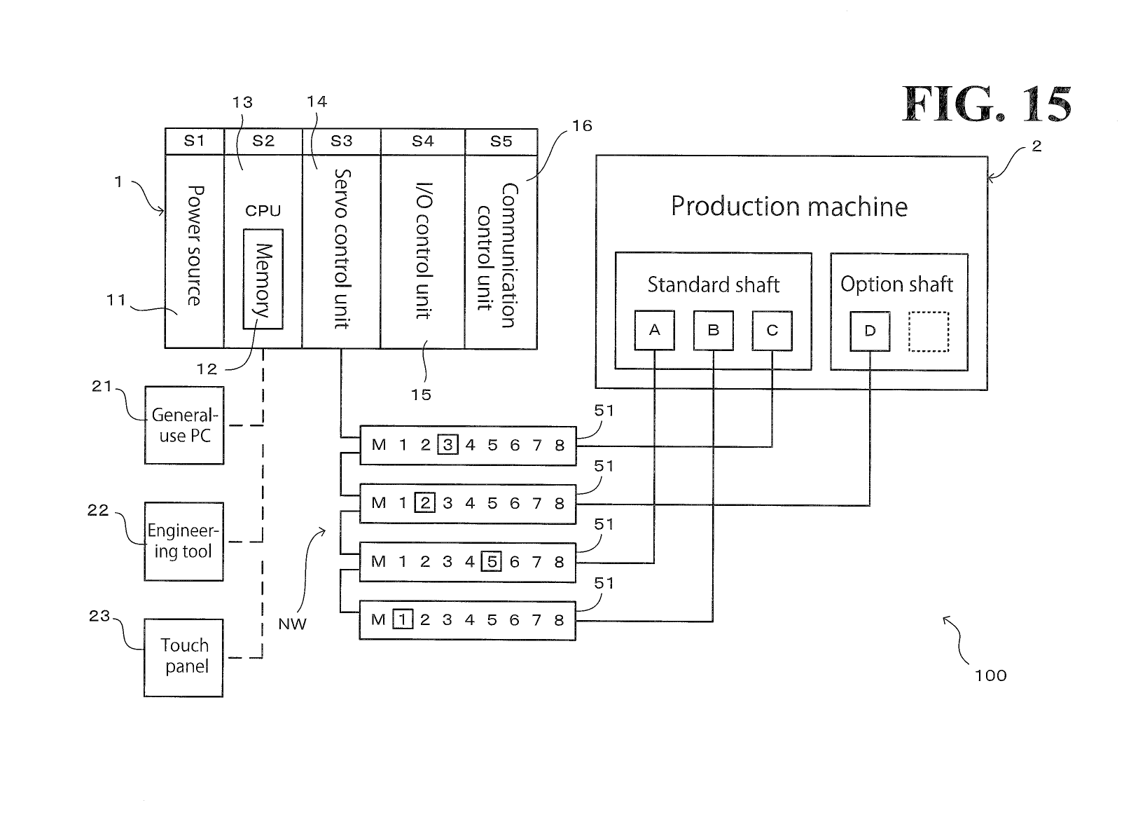

In the embodiment described above, each control unit includes the plurality of ports P1 to P5 that can be individually specified, and the control unit is connected to the control elements of the production machine 2 through the ports P1 to P5. This, however, should not be construed in a limiting sense. For example, as illustrated in FIG. 15, each control unit may be connected to a plurality of node terminals 51 through network NW, and the node terminals 51 may be respectively connected to the control elements of the production machine 2.

In the example illustrated in FIG. 15, MECHATROLINK (registered trademark) is supposed as the network NW. The servo control unit 14 and the node terminals 51 are connected in series in what is called cascade connection. The node terminals 51 made up of ASIC, for example, are compatible with each other on the hardware level. An optional and unique (not overlapping) node address as identification information is set for each node terminal 51 by predetermined software operation or hardware operation. In the example illustrated in FIG. 15, node address M3 is set for the node terminal 51 that is most closely connected to the servo control unit 14. Node address M2 is set for the second closest node terminal 51. Node address M5 is set for the third closest node terminal 51. Node address M1 is set for the fourth closest node terminal 51. The drive shaft A is connected to the node terminal 51 at node address M5. The drive shaft B is connected to the node terminal 51 at node address M1. The drive shaft C is connected to the node terminal 51 at node address M3. The drive shaft D is connected to the node terminal 51 at node address M2. It is noted that the node addresses M1 to M5 correspond to the specification information disclosed in the claims.

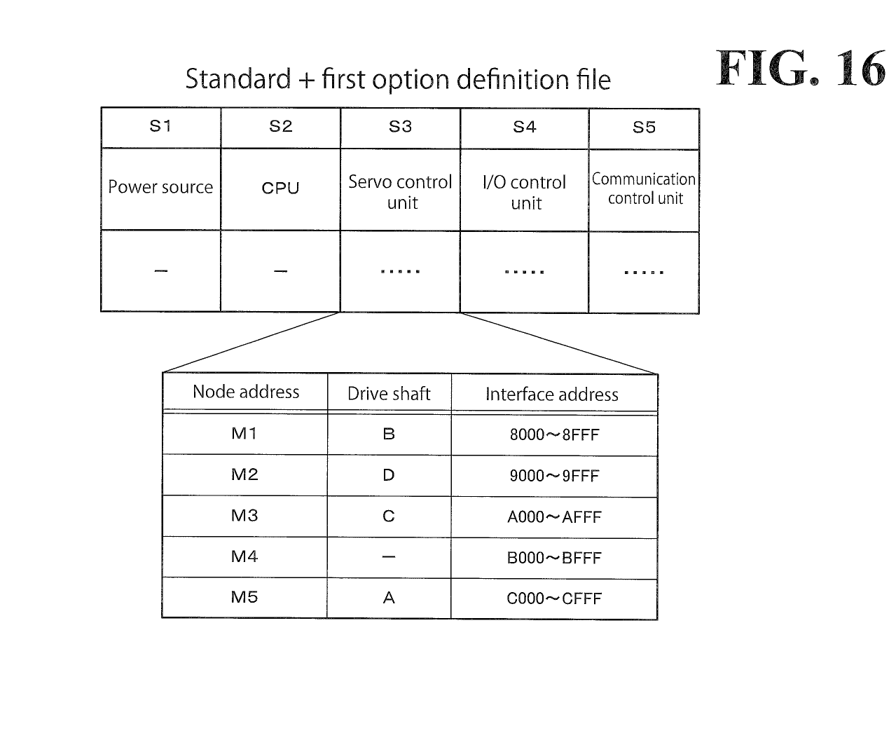

For the network connection having such a high freedom degree, it suffices that a definition file corresponding to the connection configuration is prepared, as illustrated in FIG. 16. The contents of the definition file in the example of FIG. 16 are described in a table indicating a combination, corresponding to each node address, of identification information of the drive shaft and an interface address where commands and information are actually input and output. In the control program, it suffices that when each drive shaft is controlled, the input and output of commands and information are performed with respect to the node terminal 51 at the corresponding node address based on the definition file (not illustrated).

As described above, the programmable controller 1 of this modification is connected through the network NW to the plurality of node terminals 51, which are respectively connected to the plurality of control elements. With the node addresses randomly and uniquely set respectively for the plurality of node terminals, it is specified the input-output ends of commands and/or information. Thus, the node addresses set with a high degree of freedom and randomly are used to specify the input-output ends of commands and/or information.

Otherwise, the above-described embodiments and modification may be combined in any manner deemed suitable.

Obviously, numerous modifications and variations of the present disclosure are possible in light of the above teachings. It is therefore to be understood that within the scope of the appended claims, the present disclosure may be practiced otherwise than as specifically described herein.

What is claimed as new and desired to be secured by Letters Patent of the United States is:

1. A programmable controller to control a control machine, the programmable controller comprising:
an arithmetic processor;
a storage storing:
a plurality of definition files each defining a corresponding relationship between specification information and a plurality of control elements of the control machine, the specification information specifying an input-output end from and to which the programmable controller receives and outputs at least one of a command and information; and
a control program executable by the arithmetic processor to input and output at least one of the command and the information from and to the plurality of control elements based on at least one definition file among the plurality of definition files; and
a selector configured to select the at least one definition file to use as a basis on which the arithmetic processor executes the control program.

2. The programmable controller according to claim 1, further comprising a plurality of connectors that are respectively connected to the plurality of control elements, wherein the specification information comprises information for individually specifying the plurality of connectors.

3. The programmable controller according to claim 1, wherein the programmable controller is connected through a network to a plurality of node tet respectively connected to the plurality of control elements, wherein the specification information comprises pieces of unique and random identification information respectively for the plurality of node terminals.

4. The programmable controller according to claim 1, wherein the control program is executed by the arithmetic processor to input and output at least one of the command and the information from and to a control element among the control elements that is defined as connected by the at least one definition file selected by the selector.

5. The programmable controller according to claim 1, wherein the selector is configured to select the at least one definition file at start time of the programmable controller.

6. The programmable controller according to claim 5,
wherein the storage comprises
a non-volatile storage storing the plurality of definition files and the control program, and
a volatile storage to read, from the non-volatile storage, the at least one definition file selected by the selector at the start time of the programmable controller and the control program and to store the at least one definition file and the control program, and
wherein the arithmetic processor is configured to execute the control program stored in the volatile storage based on the at least one definition file stored in the volatile storage.

7. The programmable controller according to claim 2, wherein the control program is executed by the arithmetic processor to input and output at least one of the command and the information from and to a control element among the control elements that is defined as connected by the at least one definition file selected by the selector.

8. The programmable controller according to claim 3, wherein the control program is executed by the arithmetic processor to input and output at least one of the command and the information from and to a control element among the control elements that is defined as connected by the at least one definition file selected by the selector.

9. The programmable controller according to claim 2, wherein the selector is configured to select the at least one definition file at start time of the programmable controller.

10. The programmable controller according to claim 3, wherein the selector is configured to select the at least one definition file at start time of the programmable controller.

11. The programmable controller according to claim 4, wherein the selector is configured to select the at least one definition file at start time of the programmable controller.

12. The programmable controller according to claim 7, wherein the selector is configured to select the at least one definition file at start time of the programmable controller.

13. The programmable controller according to claim 8, wherein the selector is configured to select the at least one definition file at start time of the programmable controller.

14. The programmable controller according to claim 9,
wherein the storage comprises
a non-volatile storage storing the plurality of definition files and the control program, and
a volatile storage to read, from the non-volatile storage, the at least one definition file selected by the selector at the start time of the programmable
controller and the control program and to store the at least one definition file and the control program, and
wherein the arithmetic processor is configured to execute the control program stored in the volatile storage based on the at least one definition file stored in the volatile storage.

15. The programmable controller according to claim 10,
wherein the storage comprises
a non-volatile storage storing the plurality of definition files and the control program, and
a volatile storage to read, from the non-volatile storage, the at least one definition file selected by the selector at the start time of the programmable controller and the control program and to store the at least one definition file and the control program, and
wherein the arithmetic processor is configured to execute the control program stored in the volatile storage based on the at least one definition file stored in the volatile storage.

16. The programmable controller according to claim 11,
wherein the storage comprises
a non-volatile storage storing the plurality of definition files and the control program, and
a volatile storage to read, from the non-volatile storage, the at least one definition file selected by the selector at the start time of the programmable controller and the control program and to store the at least one definition file and the control program, and
wherein the arithmetic processor is configured to execute the control program stored in the volatile storage based on the at least one definition file stored in the volatile storage.

17. The programmable controller according to claim 12,
wherein the storage comprises
a non-volatile storage storing the plurality of definition files and the control program, and
a volatile storage to read, from the non-volatile storage, the at least one definition file selected by the selector at the start time of the programmable controller and the control program and to store the at least one definition file and the control program, and
wherein the arithmetic processor is configured to execute the control program stored in the volatile storage based on the at least one definition file stored in the volatile storage.

18. The programmable controller according to claim 13,
wherein the storage comprises
a non-volatile storage storing the plurality of definition files and the control program, and
a volatile storage to read, from the non-volatile storage, the at least one definition file selected by the selector at the start time of the programmable controller and the control program and to store the at least one definition file and the control program, and
wherein the arithmetic processor is configured to execute the control program stored in the volatile storage based on the at least one defmition file stored in the volatile storage.
